(19) United States
(12) Patent Application Publication
(10) Pub. No.: US 2019/0210837 A1
(43) Pub. Date: Jul. 11, 2019

(54) RESCUE OPERATION IN AN ELEVATOR SYSTEM

(71) Applicant: Otis Elevator Company, Farmington, CT (US)

(72) Inventors: Peter Herkel, Berlin (DE); Lutz Hentschel, Berlin (DE)

(21) Appl. No.: 16/241,654

(22) Filed: Jan. 7, 2019

(30) Foreign Application Priority Data
Jan. 11, 2018 (EP) 18151282.3

(51) Int. Cl. B66B 5/02; B66B 1/34; B66B 5/00; B66B 9/00

(52) U.S. Cl. CPC B66B 5/027; B66B 9/00; B66B 5/0018; B66B 1/3461

(57) ABSTRACT

An elevator system (2) comprises an elevator car (6) configured for moving along a hoistway (4); an elevator control (13) configured for controlling the movement of the elevator car (6); and a communication circuit (18) configured for establishing a data connection (20) between the elevator system (2) and a remote service center (22). The elevator control (13) includes a safety circuit (17) configured for detecting a malfunction of the elevator system (2).

The invention relates to a rescue operation for an elevator system and to an elevator system configured for performing such a rescue operation.

An elevator system comprises at least one elevator car traveling along a hoistway between a plurality of landings. In case of a malfunction the elevator car may be stopped at a position within the hoistway between the landings. As a result, passengers may be trapped within the elevator car. A qualified mechanic has to visit the site for operating the elevator system in a manual emergency rescue operation in order to free the passengers. Waiting to be released from the elevator car is unpleasant for the passengers trapped within the elevator car.

It therefore would be desirable to provide a method of performing an emergency rescue operation which allows freeing the passengers more quickly, and an elevator system configured to perform such a method.

According to an exemplary embodiment of the invention, a method of performing a rescue operation in an elevator system comprises establishing a data connection between the elevator system and a remote service center and sending an alarm message indicating a malfunction of the elevator system from the elevator system to the remote service center. After having received the alarm message, the remote service center requests allowance from the elevator system for performing a remote manual rescue operation. In turn, the elevator system requests authentication from the remote service center to be allowed initiating an emergency rescue operation. After the remote service center and/or an operator at the remote service center have been authenticated as being allowed initiating an emergency rescue operation, a remote manual emergency rescue operation is initiated by the operator at the remote service center via the data connection.

Exemplary embodiments of the invention further include an elevator system comprising an elevator car configured for moving along a hoistway, an elevator control configured for controlling the movement of the elevator car, and a communication circuit configured for establishing a data connection between the elevator system and a remote service center. The elevator control includes a safety circuit configured for detecting a malfunction of the elevator system. In case a malfunction of the elevator system has been detected, the elevator control is configured for sending an alarm message indicating a malfunction of the elevator system via the communication circuit to the remote service center; receiving a request for initiating a manual emergency rescue operation via the communication circuit; checking whether the remote service center and/or an operator at the remote service center is allowed initiating an emergency rescue operation; and initiating a manual emergency rescue operation after a request for initiating a manual emergency rescue operation has been received and the remote service center and/or the operator at the remote service center have been confirmed as being allowed initiating an emergency rescue operation.

The manual emergency rescue operation in particular may include moving the elevator car along the hoistway to a landing and opening at least one hoistway door and at least one door of the elevator car after the elevator car has been stopped at the landing. This allows passengers trapped within the elevator car to leave the elevator car via the at least one hoistway door.

Exemplary embodiments of the invention allow an operator at a remote service center to initiate and perform a manual emergency rescue operation in order to free passengers trapped within an elevator car in case of a malfunction of the elevator system. Since there is no need to wait for a mechanic to visit the elevator system in order to initiate and perform the manual emergency rescue operation, the time the passengers have to wait to be released from the elevator car may be considerably reduced. Further, the costs for sending a mechanic to the elevator system in an emergency situation may be saved. A specific authentication procedure is carried out in order to ensure that the remote manual emergency rescue operation is carried out only by authorized and qualified persons.

A number of optional features are set out in the following. These features may be realized in particular embodiments, alone or in combination with any of the other features.

The method may include sending status information from the elevator system to the remote service center in addition to the alarm message. Said status information may help the operator at the remote service center to determine the cause of the malfunction in order to initiate appropriate countermeasures. It in particular may help the operator to decide whether a remote manual emergency rescue operation can be performed or whether it is necessary to send a mechanic to the elevator system in order to release the passengers from the elevator car. Particularly, the status information from the elevator system obtained by the remote service center may be used by the remote service person to ensure that executing a remote manual rescue operation is safe, e.g. to make sure that there are no persons in the hoistway.

The additional status information may further help determining which tools and/or spare parts are needed for solving the problem. This may facilitate and speed up the repair process.

The additional status information may include pictures from at least a portion of the hoistway above and/or below the elevator car. For providing pictures from at least a portion of the hoistway, the elevator system may comprise at least one camera configured for taking pictures from inside the hoistway. The communication circuit may be configured for sending the pictures recorded by the at least one camera via the data connection to the remote service center.

The at least one camera in particular may be configured for providing real time pictures. For example, the at least one camera may provide moving (video) pictures. Such moving pictures may be transferred to the remote service center in real time, at least after the alarm message indicating a malfunction has been sent to the remote service center and/or has been received by the remote service center. In some embodiments, it may be sufficient for the camera to provide still pictures given the camera is able to produce a series of still pictures with sufficient temporal resolution to allow a real time evaluation of the current situation in the hoistway.

The elevator system may further comprise at least one illumination device configured for illuminating at least a portion of the hoistway. The elevator control may be configured to switch on the at least one illumination device when a malfunction has been detected and/or when the at least one camera is activated. Illuminating at least a portion of the hoistway may increase the quality of the pictures recorded by the at least one camera.

Evaluating pictures from at least a portion of the hoistway above and/or below the elevator car allows the operator in the remote service center to determine whether the space above and/or below the elevator car is empty, or whether there is a person or an obstacle above and/or below the elevator car. Thus, the pictures allow the operator to decide whether it is safe to move the elevator car in a remote emergency rescue operation or whether it is necessary to send a mechanic to the elevator system, e.g. in order to remove an obstacle from the hoistway before the elevator car may be moved.

An audio connection may be established between the remote service center and the elevator car in order to allow the operator at the remote service center to communicate with passengers trapped within the elevator car.

Performing the remote manual emergency rescue operation may include moving the elevator car over a predetermined distance and/or for a predetermined period of time along the hoistway after a control signal has been received, and stopping the elevator car unless a further control signal indicating to continue moving the elevator car is received via the data connection before the elevator car has been stopped. As the elevator car is moved only over a predetermined distance and/or for a predetermined period of time every time a control signal is received, an uncontrolled movement of the elevator car is prevented even in case the data connection should be disturbed or interrupted.

Additionally or alternatively, a remote hold signal may be issued by the operator and transmitted to the elevator control. The remote hold signal need to be generated completely independently of the remote control signal. As long as the remote hold signal is received by the elevator control, the elevator car is moved in correspondence with remote control signal. Once the remote hold signal is no longer received, the elevator control stops the elevator car and does no longer react to the remote control signal. Thus, the remote control signal is not effective anymore.

The method may include checking the integrity of the elevator system in order to determine whether the issue, which caused the malfunction, still exists, and to instruct the elevator system to resume normal operation when it is determined that the problem has been solved. The integrity check may be carried out once the elevator car has reached a safe landing at the end of the remote manual emergency rescue operation. This integrity check procedure may particularly include rebooting the elevator control, e.g. as a final step in case no malfunction has been detected in the integrity check, or as a first step after the elevator car has reached a safe landing, followed by suitable integrity check procedures. Such a method allows resuming normal operation of the elevator system without a mechanic visiting the elevator system.

When it is determined that the problem has not been solved, even after performing a suitable integrity check and restore procedure, the elevator system may be shut down, and a mechanic may be instructed to visit the elevator system in order to solve the problem. In case an integrity check and restore procedure has been carried out, the communication circuit may provide additional information to the remote service center. Based on the additional information provided by the communication circuit, the mechanic may take tools and/or spare parts needed for solving the problem with him in order to facilitate and speed up the repair process.

Authenticating the remote service center and/or the operator may include using an asymmetric encryption mechanism employing a public key and a corresponding private key.

In order to decrypt encrypted messages received from the remote service center, the elevator control may comprise a decryption circuit, which is configured for decrypting and/or authenticating messages received from the remote service center.

The decryption circuit in particular may be configured for executing an asymmetric encryption mechanism. An asymmetric encryption mechanism allows for a reliable and safe authentication.

The decryption circuit may comprise a chip, in particular a smart card chip, storing a key, which is needed for encrypting and/or decrypting the messages. The chip may be soldered directly on a printed circuit board (PCB).

Alternatively, the decryption circuit may comprise a smart card reader for reading a key stored on a smart card which is inserted into the smart card reader. A smart card reader allows providing the key needed for encrypting and/or decrypting the messages conveniently via smart card. In such a configuration, the key may be changed easily by replacing the smart card.

The data connection between the elevator system and the remote service center may be established via the Internet, in particular via a virtual private network (VPN) and/or via a virtual cloud established within the Internet. The Internet allows for a reliable date connection, which is easy to implement and which allows for the transfer of large amounts of data at low costs. Sending the data via a virtual private network and/or via a virtual cloud reliably prevents unauthorized access to the data.

In the following an exemplary embodiment of the invention is described with reference to the enclosed figures.

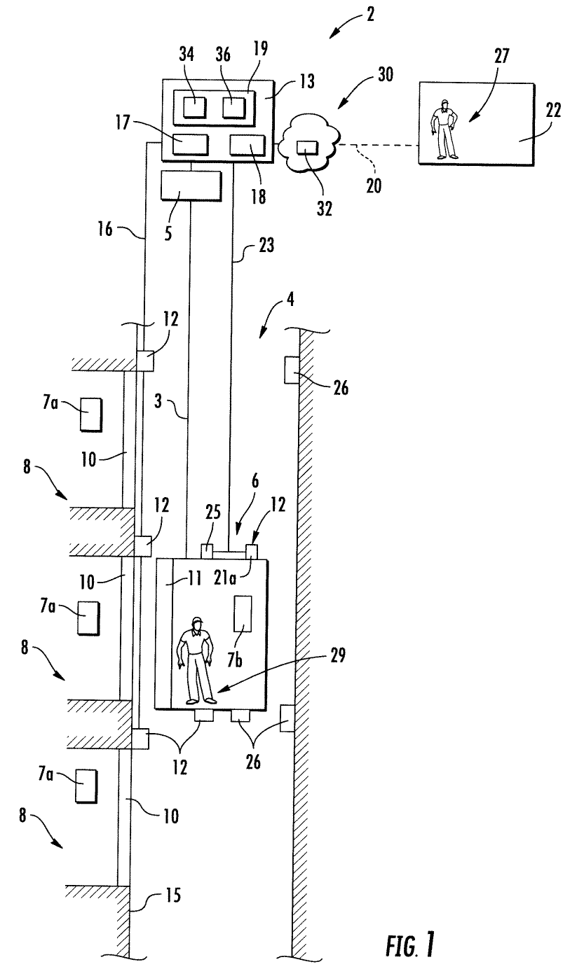

FIG. 1 schematically depicts an elevator system configured for performing a remote manual emergency rescue operation according to an exemplary embodiment of the invention.

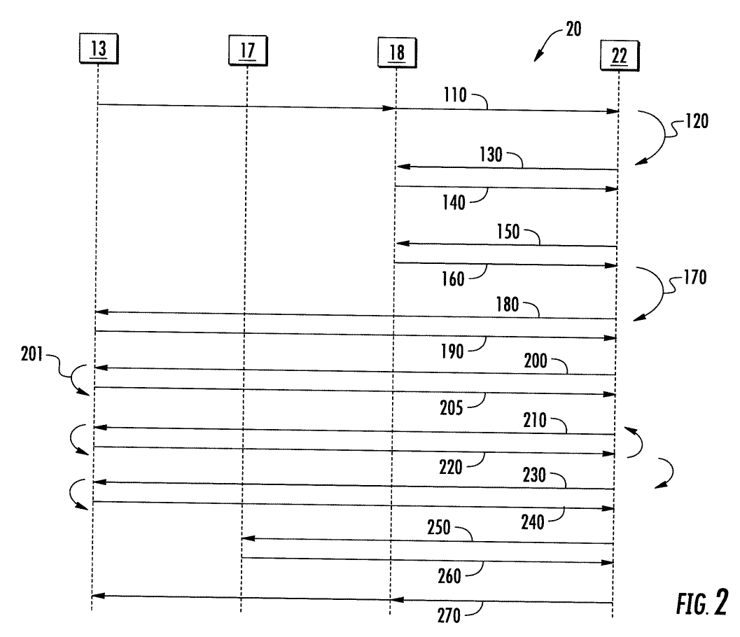

FIG. 2 schematically illustrates the steps of performing a remote manual emergency rescue operation according to an exemplary embodiment of the invention.

FIG. 1 schematically depicts an elevator system 2 configured for performing a remote manual emergency rescue operation according to an exemplary embodiment of the invention.

The elevator system 2 comprises an elevator car 6 which is movably suspended within a hoistway 4 extending between a plurality of landings 8 located on different floors.

The elevator car 6 is movably suspended by means of a tension member 3. The tension member 3, for example a rope or belt, is connected to a drive 5, which is configured for driving the tension member 3 in order to move the elevator car 6 along the height of the hoistway 4 between the plurality of landings 8.

Each landing 8 is provided with an elevator hoistway door (landing door) 10, and the elevator car 6 is provided with an elevator car door 11 allowing passengers 29 to transfer between a landing 8 and the interior of the elevator car 6 when the elevator car 6 is positioned at the respective landing 8.

The exemplary embodiment of the elevator system 2 shown in FIG. 1 employs a 1:1 roping for suspending the elevator car 6. The skilled person, however, easily understands that the type of the roping is not essential for the invention and that different kinds of roping, e.g. a 2:1 roping, may be used as well. The elevator system 2 may further include a counterweight (not shown) moving concurrently and in opposite direction with respect to the elevator car 6. Alternatively, the elevator system 2 may be an elevator system 2 without a counterweight, as it is shown in FIG. 1. The drive 5 may be any form of drive used in the art, e.g. a traction drive, a hydraulic drive or a linear drive. The elevator system 2 may have a machine room or may be a machine room-less elevator system. The elevator system 2 may use a tension member 3, as it is shown in FIG. 1, or it may be an elevator system without a tension member 3, comprising e.g. a hydraulic drive or a linear drive (not shown).

The drive 5 is controlled by an elevator control 13 for moving the elevator car 6 along the hoistway 4 between the different landings 8. The elevator control 13 comprises a safety circuit 17, which is configured for monitoring the safety of the elevator system 2. The safety circuit 17 in particular may be connected to a safety chain (not shown) comprising a plurality of safety sensor and/or safety switches. In case one of the safety sensors, and/or its corresponding safety switch, indicates an abnormal condition, the respective safety switch will open the safety chain resulting in detection of an emergency situation by the safety circuit 17.

Input to the elevator control 13 may be provided via landing control panels 7a, which are provided on each landing 8 close to the elevator hoistway doors 10, and/or via a car operation panel 7b provided inside the elevator car 6.

The landing control panels 7a and the car operation panel 7b may be connected to the elevator control 13 by means of electrical lines, which are not shown in FIG. 1, in particular by an electric bus, e.g. a field bus such as a CAN bus, or by means of wireless data connections.

In order to determine the current position of the elevator car 6, the elevator system 2 is provided with at least one position sensor 25 configured for detecting the current position (height) of the elevator car 6 within the hoistway 4.

The position sensor 25 is connected with the elevator control 13 via a signal line 23, or via a wireless connection configured for transmitting the detected position of the elevator car 6 to the elevator control 13.

In case a malfunction of the elevator system 2, such as an unscheduled stop in a position between two landings 8, is detected, a communication circuit 18 provided within, or connected with, the elevator control 13 establishes a data connection 20 between the elevator control 13 and a remote service center 22.

The data connection 20 between the elevator system 2 and the remote service center 22 may be established via the Internet 30, in particular via a virtual private network (VPN) and/or via a virtual cloud 32 within the Internet. The data connection 20 may include a conventional telephone line or a digital line such as ISDN or DSL. It further may include wireless communication including WLAN, GMS, UMTS, LTE, Bluetooth® etc.

The steps following the establishment of the data connection 20 are schematically illustrated in FIG. 2.

Via the established data connection 20, an alarm message is transmitted from the elevator control 13 via the communication circuit 18 and the data connection 20 to the remote service center 22 (step 110

An operator (technical expert) 27 at the remote service center 22 (see FIG. 1) is made aware of the malfunction the elevator system 2 (step 120), e.g. by an optical and/or acoustical signal.

The operator 27 may request further details of the current status of the elevator system 2 (step 130), which are provided via the communication circuit 18 and the data connection 20 (step 140).

Optionally, an audio connection may be established between the remote service center 22 and the elevator car 6 in order to allow the operator 27 at the remote service center 22 to communicate with passengers 29 trapped within the elevator car 6.

Upon request from the operator 27 (step 150), pictures from inside the hoistway 4 recorded by cameras 12 arranged on top and/or below the elevator car 6 (see FIG. 1) are transmitted to the remote service center 22 (step 160) and displayed to the operator 27.

The cameras 12 in particular may be configured for providing real time pictures. For example, the cameras 12 may provide moving pictures. Such moving pictures may be transferred to the remote service center 22 in real time, at least after the alarm message indicating a malfunction has been sent to the remote service center 22 and/or has been received by the remote service center 22. In some embodiments, it may be sufficient that the cameras 12 provide still pictures given the cameras 12 are able to produce a series of still pictures with sufficient temporal resolution to allow a real time evaluation of the current situation in the hoistway 4.

The cameras 12 may be attached to the elevator car 6 and/or to the walls 15 of the hoistway 4. The cameras 12 may be connected to the elevator control 13 by a camera signal line 16, by the signal line 23 extending between the elevator car 6 and the elevator control 13, or by means of a wireless connection, respectively.

Additionally, at least one light source 26, which may be mounted to a wall 15 of the hoistway 4 or to the elevator car 6, may be switched on for illuminating at least a portion of the hoistway 4. Illuminating at least a portion of the hoistway 4 allows the cameras 12 to record pictures of the interior of the hoistway 4 with good quality.

The pictures displayed to the operator 27 at the remote service center 22 allow the operator 27 to reliably determine whether the space above and/or below the elevator car 6 is empty, or whether there is a person or an obstacle above and/or below the elevator car 6.

In case the space above and/or below the elevator car 6 is empty, the operator 27 may decide to move the elevator car 6 in a remote manual emergency rescue operation (ERO) in order to free passengers 29 trapped within the elevator car 6 (step 170).

In case the operator decides for moving the elevator car 6 in a remote manual ERO, he sends a request for allowance to perform a remote manual ERO from the remote service center 22 to the elevator control 13 (step 180).

In order to prevent performing an unauthorized remote manual ERO, the elevator control 13 responds with a request for authentication to the remote service center 22 (step 190).

The remote service center 22 and/or the operator 27 authenticates itself/himself as being authorized for initiating a remote manual ERO, for example by sending an encrypted message to the elevator control 13 which identifies the remote service center 22 and/or an operator 27 as being authorized for performing a remote manual ERO (step 200).

The elevator control 13 is provided with a decryption circuit 19 which is configured for decrypting the encrypted message received from the remote service center 22 and for checking the authorization of the remote service center 22 and/or operator 27.

The encrypted message in particular may be encrypted using a secret (private) key associated with the remote service center 22 and/or operator 27. Further, the encrypted message may be decrypted by a corresponding public key stored within the elevator control 13. For additional safety, the encrypted message additionally may be encrypted using a public key of the elevator control 13 and it may be decrypted with a corresponding private key stored within the elevator control 13.

The decryption circuit 19 may comprise a chip 34, in particular a smart card chip, storing a key, which is needed for encrypting and/or decrypting the messages. The chip 34 may be soldered directly on a printed circuit board (PCB) of the decryption circuit 19.

Alternatively, the decryption circuit 19 may comprise a smart card reader 36 configured for reading an encryption key stored on a smart card which is inserted into the smart card reader 36. A smart card reader 36 allows providing the key needed for encrypting and/or decrypting the messages conveniently via smart card. In such a configuration, the key may be changed easily by replacing the smart card.

After the identity and the authorization of the remote service center 22 and/or operator 27 at the remote service center 22 have been confirmed, the elevator control 13 switches to the emergency rescue mode (ERO) (step 201) and sends a corresponding message to the remote service center 22 confirming that the ERO has been initiated (step 205).

During the ERO, the elevator drive 5 is controlled manually. In a conventional ERO a specific ERO control panel (not shown) provided at the elevator system 2 is used for controlling the elevator car 6 manually to move to a safe landing 8. In the remote manual ERO according to exemplary embodiments as described herein, the elevator drive 5 is controlled remotely from the remote service center 22 by sending appropriate commands from the remote service center 22 via the data connection 12 to the elevator control 13.

Thus, the operator 27 controls the elevator drive 5 to move the elevator car 6 upwards or downwards towards a landing 8 by sending appropriate control signals via the data connection 20 (step 210). When operated in the remote manual ERO, the elevator control 13 continuously sends feedback signals indicating the current position of the elevator car 6 within the hoistway 4 (step 220).

In order to ensure a safe operation in the remote manual ERO, the elevator car 6 moves only over a predetermined distance D, particularly 10 mm≤D≤500 mm, more particularly 50 mm≤D≤250 mm, or over a predetermined time period T, particularly 0.5 s≤T≤3 s, more particularly 1 s≤T≤2 s after a remote control signal as been issued by the operator 27.

In order to move the elevator car 6 further, a new remote control signal (step 210) has to be sent to the elevator control 13. Thus, in order to move the elevator car 6 over some distance up to a landing 8, a series of control signals has to be issued.

In an alternative configuration, a remote hold signal may be transmitted to the elevator control 13 in addition to the remote control signal. Such a remote hold signal is generated completely independently of the remote control signal. As long as the remote hold signal is received by the elevator control 13, the elevator car 6 is moved in correspondence with remote control signal. Once the remote hold signal is no longer received, the elevator control 13 stops the elevator car 6 and does no longer react to the remote control signal. Thus, the remote control signal is not effective anymore.

Since control signals can be transmitted from the remote service center 22 to the elevator control 13 only as long as the data connection 20 is intact, the elevator car 6 stops in case the data connection 20 is interrupted. As a result, an uncontrolled movement of the elevator car 6 is prevented even in case the data connection 20 might be interrupted.

After the elevator car 6 has reached a safe landing 8, the operator 27 opens the respective hoistway door 10 and the elevator car door 11 (step 230) in order to allow passengers 29 trapped within the elevator car 6 to leave the elevator car 6. The opening of the doors 10, 11 is confirmed by a corresponding message sent from the elevator control 13 to the remote service center 22 (step 240).

After the elevator car 6 has reached a safe landing 8, the doors 10, 11 have been opened and all passengers 29 have left the elevator car 6, the operator 27 may trigger the safety circuit 17 to check the integrity of the elevator system 2 (step 250) in order to determine whether the issue which has caused the malfunction and the alarm message still exists, or whether the problem has been solved by manually moving the elevator car 6. This check may include rebooting the elevator control 13.

When the safety circuit 17 reports that the problem has been solved (step 260), the operator 27 may terminate the remote manual ERO and instruct the elevator system 2 to resume normal operation (step 270).

In case the check reveals that the problem has not been solved, the operator 27 may shut down the elevator system 2 and instruct a mechanic to visit the elevator system 2 in order to solve the problem on site. Based on the information provided by the communication circuit 18, the mechanic may take the tools and/or spare parts needed for solving the problem with him in order to facilitate and speed up the repair process.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention is not limited to the particular embodiments disclosed, but that the invention includes all embodiments falling within the scope of the claims.

### REFERENCES

2 elevator system
3 tension member
4 hoistway
5 drive
6 elevator car
7a landing control panel
7b car operation panel
8 landing
10 hoistway door
11 elevator car door
12 camera
13 elevator control
15 wall of the hoistway
16 camera signal line
17 safety circuit
18 communication circuit
19 decryption circuit
20 data connection
22 remote service center
23 signal line
25 position sensor
26 illumination device
27 operator
29 passenger
30 Internet
32 virtual cloud
34 chip
36 smart card reader

What is claimed is:

1. Method of performing a rescue operation in an elevator system (2) comprising an elevator car (6) moving along a hoistway (4), wherein the method comprises:
establishing a data connection (20) between the elevator system (2) and a remote service center (22), and sending an alarm message indicating a malfunction of the elevator system (2) from the elevator system (2) to the remote service center (22);
the remote service center (22) requesting allowance from the elevator system (2) to perform a remote manual rescue operation;
the elevator system (2) requesting authentication from the remote service center (22);
authenticating the remote service center (22) and/or an operator (27) at the remote service center (22) as being allowed initiating an emergency rescue operation;
initiating a remote manual emergency rescue operation via the data connection (20).

2. Method according to claim 1, wherein the manual emergency rescue operation includes moving the elevator car (6) to a landing (8) and opening at least one hoistway door (10) at the landing (8) and at least one door (10) of the elevator car (6) after the elevator car (6) has been stopped at the landing (8).

3. Method according to claim 1, wherein the method further includes sending status information from the elevator system (2) to the remote service center (22) in addition to the alarm message.

4. Method according to claim 3, wherein the status information includes moving and/or still pictures from at least a portion of the hoistway (4) above and/or below the elevator car (6).

5. Method according to claim 4, wherein the method includes illuminating at least a portion of the hoistway (4).

6. Method according to claim 1, wherein the manual emergency rescue operation includes moving the elevator car (6) over a predetermined distance and/or for a predetermined period of time along the hoistway (4) and stopping the elevator car (6) unless a control signal indicating to continue moving the elevator car (6) is received via the data connection (20) before the elevator car (6) has been stopped.

7. Method according to claim 1, wherein the manual emergency rescue operation includes transmitting a remote hold signal to the elevator control (13) and moving the elevator car (6) in correspondence with remote control signal only as long as the remote hold signal is received.

8. Method according to claim 1, wherein the method includes checking the integrity of the elevator system (2) and terminating the remote manual emergency rescue operation resuming normal operation of the elevator system (2) when the integrity of the elevator system (2) has been confirmed.

9. Method according to claim 1, wherein authenticating the remote service center (22) and/or an operator (27) includes using an asymmetric encryption mechanism employing a public key and a corresponding private key.

10. Method according to claim 1, wherein the data connection (20) between the elevator system (2) and the remote service center (22) is established via the Internet (30), in particular via a virtual private network and/or via a virtual cloud (32).

11. Elevator system (2) comprising
an elevator car (6) configured for moving along a hoistway (4);
an elevator control (13) configured for controlling the movement of the elevator car (6); and
a communication circuit (18) configured for establishing a data connection (20) between the elevator system (2) and a remote service center (22);
wherein the elevator control (13) includes a safety circuit (17) configured for detecting a malfunction of the elevator system (2), and wherein the elevator control (13) is configured for performing the following actions in case a malfunction of the elevator system (2) has been detected:
establishing a data connection (20) between the elevator system (2) and a remote service center (22) and sending an alarm message indicating a malfunction of the elevator system (2) via the communication circuit (18) to the remote service center (22);
receiving a request for initiating a manual emergency rescue operation via the communication circuit (18);
checking whether the remote service center (22) and/or an operator (27) at the remote service center (22) is allowed initiating an emergency rescue operation; and
initiating a manual emergency rescue operation after the remote service center (22) and/or an operator (27) at the remote service center (22) have been confirmed as being allowed initiating an emergency rescue operation.

12. Elevator system according to claim 11,
further comprising at least one camera (12) configured for taking moving and/or still pictures from inside the hoistway (4), wherein the communication circuit (18) is configured for sending the pictures recorded by the at least one camera (12) via the communication circuit (18) to the remote service center (22).

13. Elevator system (2) according to claim 11,
further comprising at least one illumination device (26) which is configured for illuminating at least a portion of the hoistway (4), wherein the elevator control (13) in particular is configured to switch on the at least one illumination device (26) when a malfunction has been detected.

14. Elevator system (2) according to claim 11,
further comprising a decryption circuit (19), which is configured for decrypting and/or authenticating messages received from the remote service center (22), wherein the decryption circuit (19) in particular is configured for employing an asymmetric encryption mechanism.

15. Elevator system according to claim 14,
wherein the decryption circuit (19) comprises a chip (34), in particular a smart card chip (34), storing a key, which is needed for encrypting and/or decrypting the messages, or a smart card reader (36) configured for reading an encryption key stored on a smart card.
